(19) United States
(12) Patent Application Publication
(10) Pub. No.: US 2017/0120668 A1
(43) Pub. Date: May 4, 2017

(54) REAR CASE FOR ELECTRONIC DEVICE

(71) Applicants: SAMWON ST, Cheongju-si (KR); ELK CORPORATION, Daejeon (KR)

(72) Inventor: Chul PARK, Gyeonggi-do (KR)

(21) Appl. No.: 15/301,374

(22) PCT Filed: Apr. 1, 2015
(86) PCT No.: PCT/KR2015/003254

§ 371 Date: Sep. 30, 2016

(30) Foreign Application Priority Data
Apr. 1, 2014 (KR) 10-2014-0038445
May 2, 2014 (KR) 10-2014-0053301
Jun. 13, 2014 (KR) 10-2014-0071775
Jul. 21, 2014 (KR) 10-2014-0091978
Nov. 28, 2014 (KR) 10-2014-0167942
Nov. 28, 2014 (KR) 10-2014-0167944

(51) Int. Cl. B44C 1/18; B41M 1/28; B41M 1/12

(52) U.S. Cl. CPC B44C 1/18; B41M 1/12; B41M 1/28

(57) ABSTRACT

Disclosed is a rear case for an electronic device, which can express a design characteristic of a metal texture without interrupting an electromagnetic signal. The rear case provided on the rear surface of the electronic device comprises: a transparent substrate disposed on the rear surface of the electronic device; and a metal decoration made of a metallic material and provided on one surface of the transparent substrate, wherein the metal decoration includes a plurality of metal thin-film figures electrically insulated from each other.

### TECHNICAL FIELD

The present invention relates to a rear case for an electronic device, and more particularly, to a rear case for an electronic device which can express a design characteristic of a metal texture without interrupting an electromagnetic signal.

### BACKGROUND ART

In general, a rear case is provided on the rear surface of an electronic device such as a smart phone, a tablet, a laptop, and a monitor.

A plastic material is mainly used as a material of the rear case for the electronic device, but it is difficult to express an advanced texture due to a characteristic of the plastic material.

Meanwhile, recently, the performance of the electronic device is important, but an external design of the electronic device is equally important. For example, according to a survey focused on purchasers, it is shown that the first thing considered when purchasing products is just a ‘design’. It is a result that the external design of the product has a large effect on the purchase of the product as much as that.

The rear case basically serves to protect internal constituent elements of the electronic device and can express an exterior design of the electronic device. To this end, recently, various studies for materials of the rear case capable of having unique design effects have been conducted so as to satisfy the rapidly changing needs of consumers.

As an example, recently, various attempts for forming the rear case with a metallic material such as aluminum have been made.

Meanwhile, when a metallic material is used as the material of the rear case, a unique design characteristic of a metal texture may be expressed. However, when the rear case is formed of the metallic material, there is a problem in that a unique characteristic of the metal modifies the electromagnetic signals (for example, antenna radio signals) to interrupt communication.

Accordingly, recently, various studies for the rear case capable of expressing the unique design characteristic without interrupting an electromagnetic signal have been conducted, but are not yet sufficient and thus the development thereof has been required.

### DISCLOSURE

### Technical Problem

The present invention is directed to provide a rear case for an electronic device, which can express a design characteristic of a metal texture without interrupting an electromagnetic signal.

Particularly, the present invention is also directed to provide a rear case for an electronic device capable of expressing a design characteristic of a metal texture by using a metallic material and preventing modification of an electromagnetic signal such as an antenna signal.

Further, the present invention is also directed to provide a rear case for an electronic device capable of preventing reflection of light caused by a metal decoration by forming finely curved parts and a flat part on a transparent substrate and simultaneously expressing an advanced and unique design effect by reflecting the light at the outermost edge.

Further, the present invention is also directed to provide a rear case for an electronic device capable of improving a metal decoration effect by forming the metal decoration in a multilayered metal structure.

Further, the present invention is also directed to provide a rear case for an electronic device capable of improving a product value, contributing to the advanced product, and enhancing the satisfaction of consumers.

### Technical Solution

One aspect of the present invention provides a rear case for an electronic device provided on the rear surface of the electronic device comprises: a transparent substrate disposed on the rear surface of the electronic device; and a metal decoration made of a metallic material and provided on one surface of the transparent substrate, in which the metal decoration includes a plurality of metal thin-film figures electrically insulated from each other.

For reference, in the present invention, it can be understood that the rear case includes both a case which is disposed on the outermost rear surface of the electronic device to be directly exposed to the outside and a case which can be stacked on the rear surface of the electronic device. Further, the rear case of the present invention may be attached to a case of the electronic device or integrated with the case by a two-shot injection method during injection-molding of the case, and may be used as a protective film having an adhesive formed on one surface.

The metal decoration is formed by a plurality of metal thin-film figures electrically insulated from each other. For reference, it can be understood that the metal thin-film figures mean to include at least one shape of polygons, circles, ovals, and hairlines.

The sizes of the metal thin-film figures may be appropriately changed according to requirements and design specifications. Preferably, the metal thin-film figures may be formed with sizes without causing interference of electromagnetic signals such as antenna signals.

For example, the plurality of metal thin-film figures may be formed to have sizes of 10 to 1,000 mm and the respective metal thin-film figures may be spaced apart from each other with gaps of 2 to 100 mm therebeween. In some cases, the sizes and the separation gaps of the metal thin-film figures can be formed by nanometer units.

The finely curved parts corresponding to the metal decoration may be formed on the transparent substrate so as to prevent reflection (a reflective mirror effect) of light caused when the metal decoration is made of a metallic material.

For reference, in the present invention, it can be understood that the case where that the finely curved parts corresponding to the metal decoration are formed on the transparent substrate is a case where the metal decoration and the finely curved parts are disposed in an overlapped area in planar projection.

The finely curved parts may be formed on one surface or the other surface of the transparent substrate according to requirements and design specifications. As an example, the finely curved parts may be formed on the inner surface (one surface) of the transparent substrate and the metal decoration may be formed on one surface of the transparent substrate to cover the finely curved parts. In some cases, the metal decoration may be formed on the inner surface of the transparent substrate and the finely curved parts may be formed on the outer surface of the transparent substrate. Unlike this, the finely curved parts may be provided on one surface of the transparent substrate to cover the metal decoration.

Further, a non-processed flat part may be provided between the outermost edge of the transparent substrate and the finely curved parts. Herein, it can be understood that the flat part is a flat portion where the finely curved parts are not formed (not processed or not treated).

Further, the rear case for the electronic device may further include a printing layer formed on the lower surface of the metal decoration. The printing layer may express a new design effect through a texture difference from the metal thin-film figures in addition to a light leakage prevention effect.

Further, the transparent substrate according to the present invention may include a metal line formed along the outermost edge of the transparent substrate, an oxide thin-film layer formed on the transparent substrate, an inorganic thin-film layer formed to cover the finely curved parts, and a protective coating layer formed to cover the metal decoration.

### Advantageous Effects

According to the present invention, it is possible to prevent interference of electromagnetic signals while expressing a design characteristic of a metal texture, by using the metal decoration including the plurality of metal thin-film figures.

Particularly, it is possible to prevent modification of an electromagnetic signal caused by a metal characteristic while expressing an advanced design characteristic of a metal texture, by using a plurality of metal thin-film figures which is electrically insulated from each other as the metal decoration.

Further, it is possible to prevent reflection (a reflective mirror effect) of light caused when the metal decoration is made of the metallic material, by forming the finely curved parts on the transparent substrate.

Further, the finely curved parts and the metal decoration made of the metallic material are formed on different surfaces of the transparent substrate and the light incident to the transparent substrate may be first scattered while passing through the finely curved parts, thereby minimizing reflecting of light caused by the metal decoration.

Further, since the finely curved parts serving as the scattering layer where the light is scattered and the flat part serving as a mirror surface where the light is reflected coexist on the transparent substrate, the light may be reflected at the outermost edge of the transparent substrate and the light may be scattered at the inner edge thereof, thereby expressing more advanced and unique design effects.

Furthermore, when the transparent substrate is made of a glass or tempered glass material, it is possible to prevent the damage and cracks to the relatively weak edge part (the outermost edge) of the transparent substrate by providing the non-processed flat part between the outermost edge of the transparent substrate and the finely curved parts.

Further, it is possible to express a new design effect through a texture difference from metal thin-film figures in addition to a light leakage prevention effect by forming a printing layer to cover the metal decoration.

Further, the metal decoration is formed in a multilayered metal structure, thereby more improving the metal decoration effect.

Further, it is possible to improve a design characteristic and improve a product value. Therefore, it is possible to contribute to the advanced product and enhance satisfaction of customers.

### DESCRIPTION OF DRAWINGS

FIG. 1 is a diagram for describing a rear case for an electronic device according to the present invention.

FIG. 2 is a diagram for describing a metal decoration as the rear case for the electronic device according to the present invention.

FIGS. 3 to 5 are diagrams for describing a method for manufacturing a rear case for an electronic device according to the present invention.

FIG. 6 is a diagram for describing a rear case for an electronic device according to another exemplary embodiment of the present invention.

FIGS. 7 to 9 are diagrams for describing a method for manufacturing a rear case for an electronic device according to another exemplary embodiment of the present invention.

FIG. 10 is a diagram for describing a rear case for an electronic device according to yet another exemplary embodiment of the present invention.

FIG. 11 is a diagram for describing a metal line, as the rear case for the electronic device according to the present invention.

FIG. 12 is a diagram for describing an oxide thin-film layer as the rear case for the electronic device according the present invention.

FIGS. 13 and 14 are diagrams for describing an inorganic thin-film layer as the rear case for the electronic device according the present invention.

FIG. 15 is a diagram for describing a protective coating layer as the rear case for the electronic device according the present invention.

FIGS. 16 and 17 are diagrams for describing a stacked structure with a transparent substrate, as the rear case for the electronic device according the present invention.

FIG. 18 is a diagram for describing a modified example of finely curved parts, as the rear case for the electronic device according to the present invention.

### BEST MODE

Hereinafter, preferred embodiments of the present invention will be described in detail with reference to the annexed drawings, but should be not construed as limiting or restricting the present invention. For reference, in this specification, the same reference numerals designate substantially the same elements. Under such a rule, contents described in other drawings may be cited and described and contents that are determined obviously to those skilled in the art or repeated may be omitted.

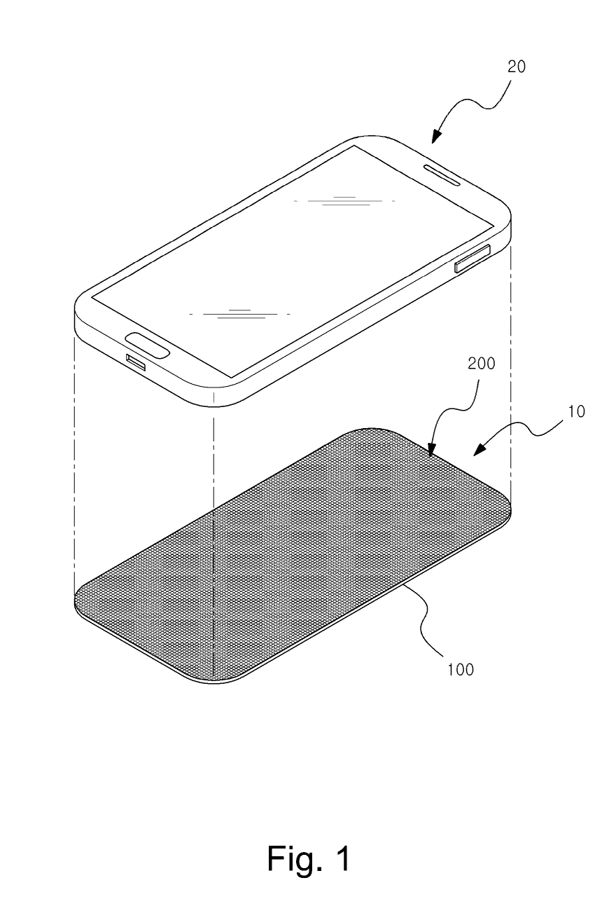

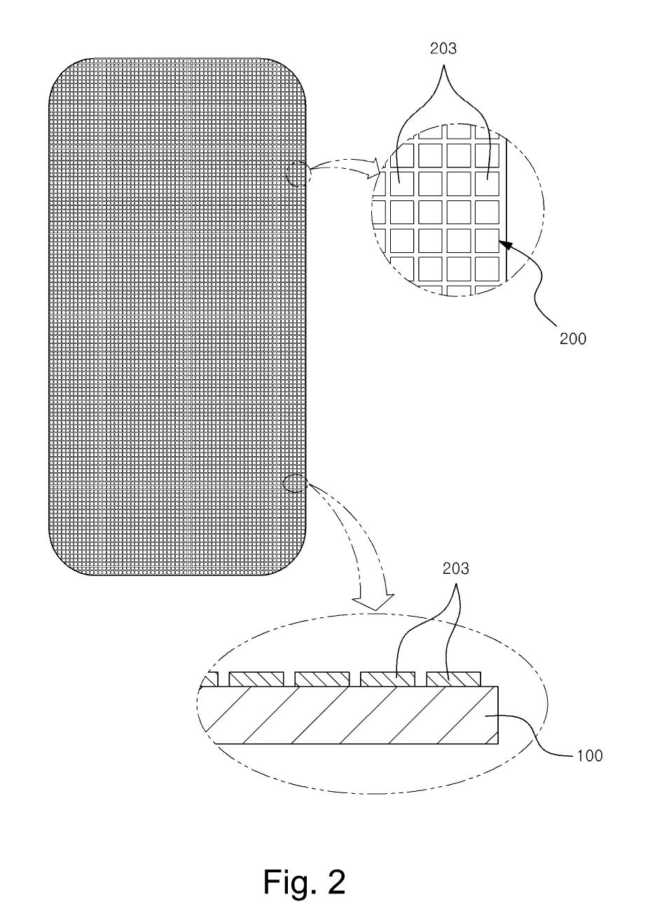

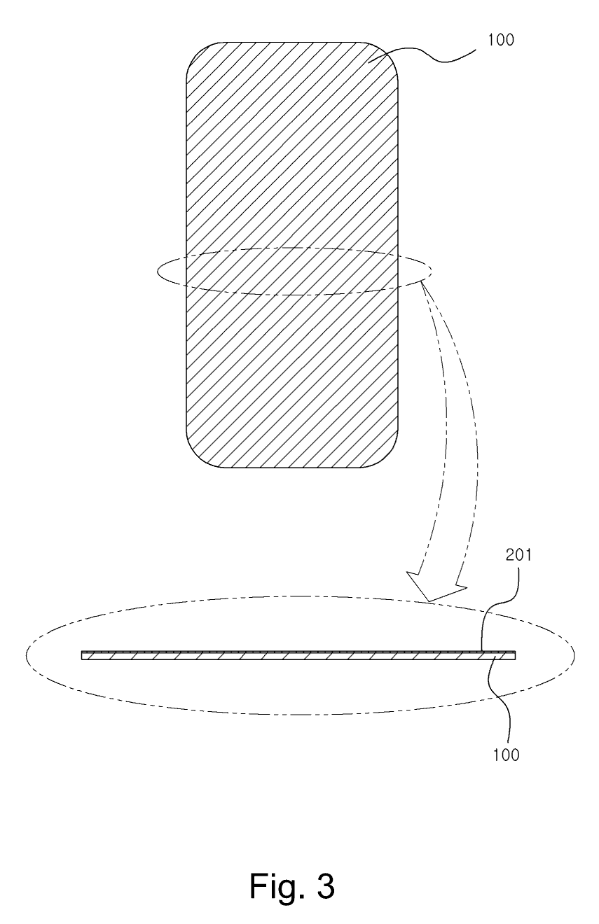

FIG. 1 is a diagram for describing a rear case for an electronic device according to the present invention and FIG. 2 is a diagram for describing a metal decoration as the rear case for the electronic device according to the present invention. Further, FIGS. 3 to 5 are diagrams for describing a method for manufacturing a rear case for an electronic device according to the present invention.

Referring to FIGS. 1 and 2, a rear case 10 for an electronic device according to the present invention includes a transparent substrate 100 and a metal decoration 200.

For reference, in the present invention, an electronic device 20 may include a smart phone, a tablet, a smart watch, a laptop computer, a monitor, and the like and the present invention is not limited or restricted by types and characteristics of the electronic device.

The transparent substrate 10 is disposed on the rear surface of the electronic device 20 and the metal decoration 200 is formed on one surface of the transparent substrate 10 so as to express the design characteristic of the metal texture.

The metal decoration 200 may be partially or entirely formed on one transparent substrate 10 and preferably, may be formed so as not to interrupt the electromagnetic signal (for example, an antenna radio signal) of the electronic device.

The transparent substrate 100 may be made of general glass, tempered glass, or sapphire, or a general plastic material such as polyethylene terephthalate (PET) or polycarbonate having transmissivity and excellent strength, and the present invention is not limited or restricted by materials and characteristics of the transparent substrate 100. For reference, the transparent substrate may be disposed on the rear surface of the electronic device, but in some cases, other substrates can be stacked on the outer surface of the transparent substrate.

The metal decoration 200 is made of a metallic material and formed on one surface of the transparent substrate 100. Herein, it can be understood that one surface of the transparent substrate 100 means to include both the outer surface and the inner surface of the transparent substrate 100. Hereinafter, an example in which the metal decoration 200 is formed on the inner surface of the transparent substrate 100 will be described.

More particularly, at least a part of the metal decoration 200 may be formed by a plurality of metal thin-film FIGS. 203 which is electrically insulated from each other. For reference, it can be understood that the metal thin-film FIGS. 203 means to include at least one shape of polygons, circles, ovals, and hairlines.

As such, in the present invention, the metal decoration 200 formed by the plurality of metal thin-film FIGS. 203 which is electrically insulated from each other is used, thereby expressing a design characteristic of a metal texture through the metal decoration 200 and preventing interruption of transmitting and receiving radio signals which is caused when the metal decoration 200 is made of a metallic material.

Hereinafter, a method for manufacturing a rear case for an electronic device according to the present invention will be described with reference to FIGS. 3 to 5.

The method for manufacturing a rear case 10 for the electronic device according to the present invention includes providing a transparent substrate 100, and forming a metal decoration 200 made of a metallic material on one surface of the transparent substrate 100. The metal decoration 200 is provided by including a plurality of metal thin-film FIGS. 203 electrically insulated from each other.

The metal decoration 200 including the metal thin-film FIGS. 203 may be formed by various methods according to requirements.

As an example, referring to FIG. 3, first, the transparent substrate 100 is provided, a metal thin-film layer 201 is formed on the transparent substrate 100, and then the metal thin-film layer 201 is partially removed to form the metal thin-film FIGS. 203.

The metal thin-film layer 201 may be formed on the surface of the transparent substrate 100 by a general method including thermal deposition, e-beam deposition, sputtering, and the like. The present invention is not limited or restricted by kinds and characteristics of the materials for forming the metal thin-film layer 201. As an example, the metal thin-film layer 201 may be formed in a single-layered or multilayered structure by using at least one of chromium, aluminum, tin, palladium, molybdenum, copper, gold, titanium, and indium. Preferably, the metal thin-film layer 201 may be formed with a thickness of 10 to 500 nm.

In some cases, before the metal thin-film layer is formed, an oxide thin-film layer such as alumina (Al₂O₃), silicon dioxide (SiO₂), and titanium dioxide (TiO₂) is coated on the surface of the transparent substrate, and then the metal thin-film layer may be formed on the surface of the oxide thin-film.

In the exemplary embodiment of the present invention described and illustrated above, the example in which the metal thin-film layer 201 is formed by the single metal layer. However, in some cases, the metal thin-film layer may be provided in a multilayered structure made of different or similar materials and the metal thin-film figures formed by removing the metal thin-film layer may also be provided in a multilayered metal structure.

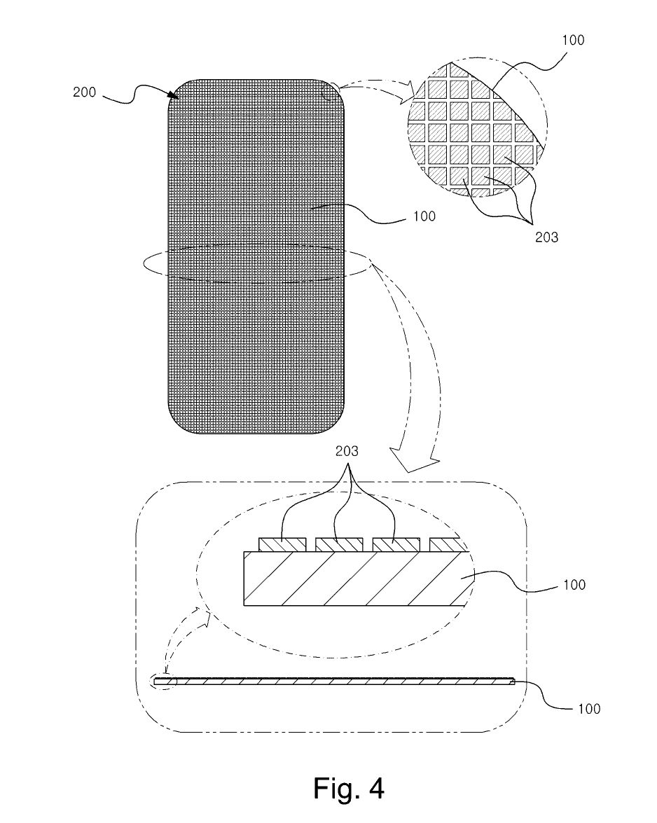

Thereafter, after a mask layer (not illustrated) is formed on the surface of the metal thin-film layer 201, the metal thin-film layer 201 is partially etched by using the mask layer to form the plurality of metal thin-film FIGS. 203 insulated from each other, as illustrated in FIG. 4. For reference, the plurality of metal thin-film FIGS. 203 may be formed by a general photolithography process.

The plurality of metal thin-film FIGS. 203 may be spaced apart from each other to correspond to the mask layer in the etching process, and the respective metal thin-film FIGS. 203 may be spaced apart from each other to be electrically insulated from each other. By such a structure, the respective metal thin-film FIGS. 203 may be electrically insulated from each other to prevent electromagnetic signals such as antenna signals from interfering by the metal characteristics of the metal thin-film FIGS. 203. Furthermore, the mask layer used for etching the metal thin-film figures may be removed before a printing layer is formed, but in some cases, the printing layer may be formed without removing the mask layer.

For reference, in the present invention, an example in which the metal thin-film FIGS. 203 are formed in quadrangular shapes will be described. In some cases, the metal thin-film figures may be formed in other polygonal shapes such as triangles and hexagons or formed in shapes such as circles, ovals, or amorphous shapes. Unlike this, the metal thin-film figures may be formed in hairline shapes.

Further, in the exemplary embodiment of the present invention described and illustrated above, the example in which the metal decoration is formed by the plurality of metal thin-film figures insulated from each other is described. However, in some cases, the metal thin-film layer itself can be used as the metal decoration without a separate etching process. For example, in the case of the metal thin-film layer made of a specific metallic material having a very small thickness of 1 to several nanometers, since metal atoms are not connected to each other to have electrical insulation, a very thin metal thin-film layer itself may be used as the metal decoration without a separate etching process.

Meanwhile, the size of the metal thin-film FIG. 203 may be appropriately changed according to requirements and design specifications. For reference, the metal thin-film may be formed with any general size, but may be formed with any size enough not to cause interference of the antenna signals. For example, the metal thin-film FIGS. 203 may be formed to have sizes of 10 to 1,000 mm and the respective metal thin-film FIGS. 203 may be spaced apart from each other with gaps of 2 to 100 mm therebetween. In some cases, the sizes and the separation gaps of the metal thin-film figures can be formed by nanometer units.

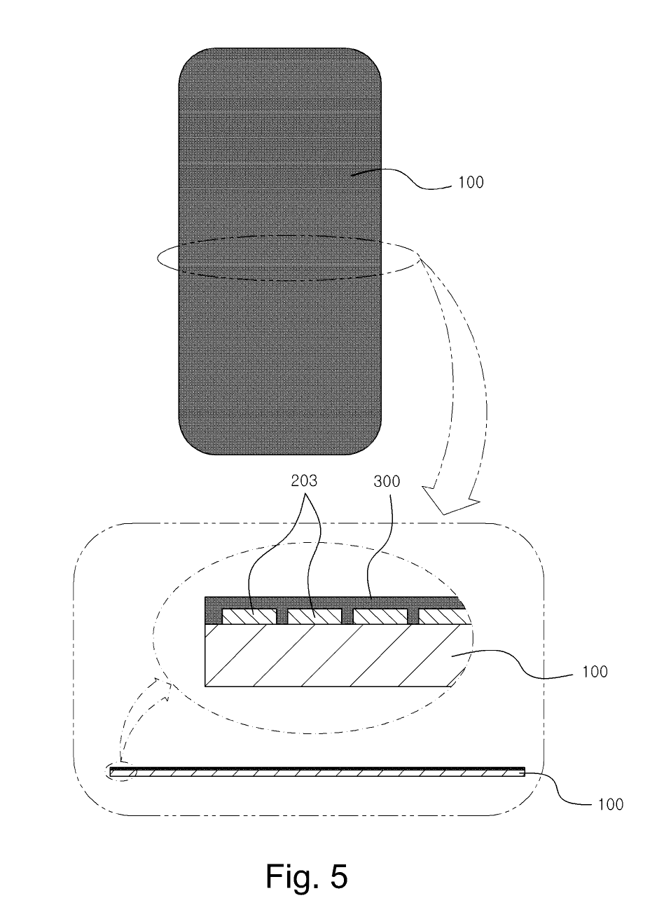

Meanwhile, referring to FIG. 5, the rear case 10 for the electronic device according to the present invention may include a printing layer 300 formed on the inner surface of the metal decoration 200 to cover the metal decoration 200. The printing layer 300 may express a new design effect through a texture difference from the metal thin-film FIGS. 203 in addition to a light leakage prevention effect.

The printing layer 300 may be formed through a general silkscreen printing method and the like and provided to have a thickness of approximately 5 to 20 mm.

Further, the printing layer 300 may prevent static electricity from being accumulated in the metal thin-film FIGS. 203. To this end, the printing layer 300 may be formed of an electrically conductive material, and preferably, the printing layer 300 may be made of a high resistive material having a specific resistance which is greater than 1 Ωcm.

For reference, the printing layer 300 may have electric conductivity by adding at least one of carbon powder, metallic powder, and nanoconductive powder to printing ink. In some cases, the printing layer may be configured to have electric conductivity by other different methods. Unlike this, the printing layer can be formed by using non-conductive colored, black, and color ink.

The printing layer 300 may be printed once or many times, and a formation condition of the printing layer 300 may be appropriately changed according to requirements and design specifications.

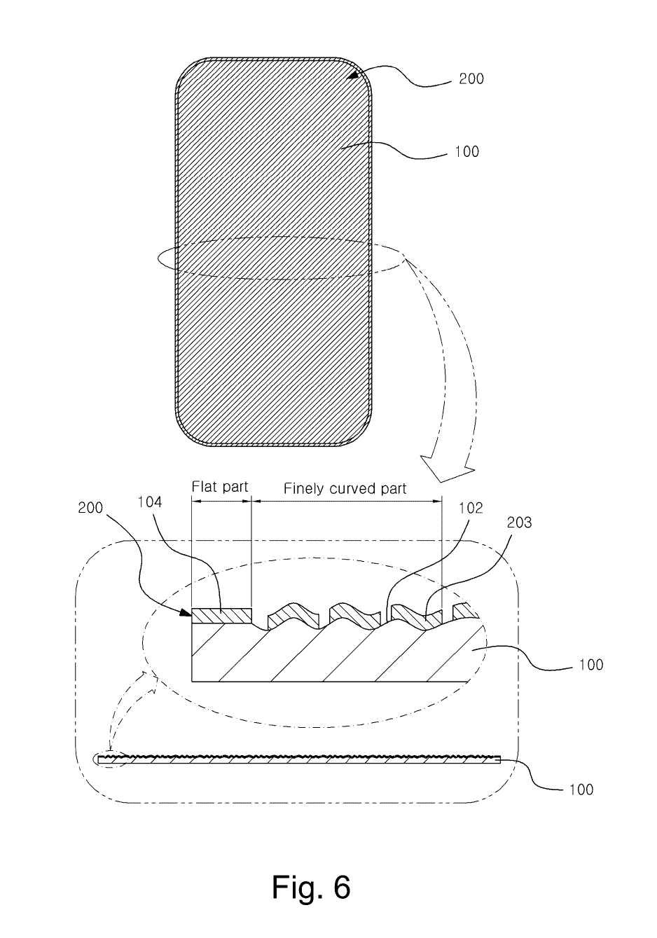

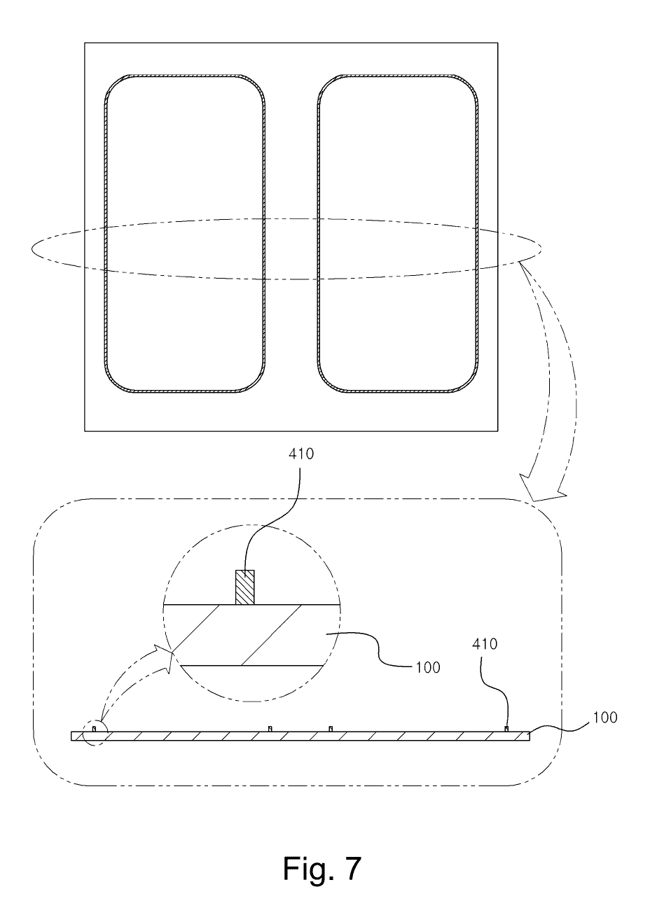

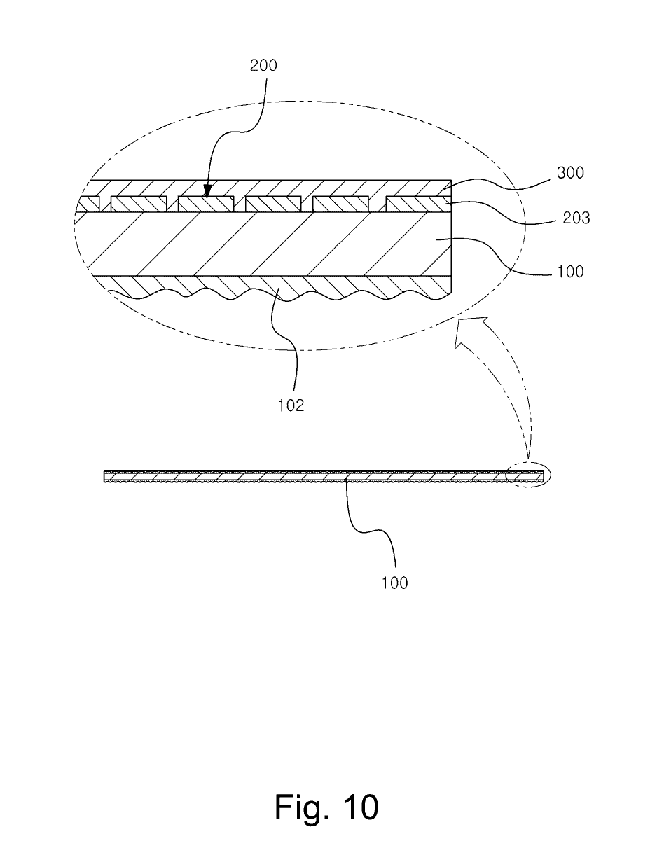

Meanwhile, FIG. 6 is a diagram for describing a rear case for an electronic device according to another exemplary embodiment of the present invention, and FIGS. 7 to 9 are diagrams for describing a method for manufacturing a rear case for an electronic device according to another exemplary embodiment of the present invention. FIG. 10 is a diagram for describing a rear case for an electronic device according to yet another exemplary embodiment of the present invention. Furthermore, the same and equivalent parts as the aforementioned configurations designate the same or equivalent reference numerals, and the detailed description thereof will be omitted.

Referring to FIGS. 6 to 9, a rear case 10 for an electronic device according to another exemplary embodiment of the present invention includes a transparent substrate 100 and a metal decoration 200, and finely curved parts 102 corresponding to the metal decoration 200 may be formed on the transparent substrate 100.

The finely curved parts 102 may be formed to prevent reflection (a reflective mirror effect) of light caused when the aforementioned metal decoration 200 is made of the metallic material.

For reference, in the present invention, it may be understood that the case that the finely curved parts 102 corresponding to the metal decoration 200 are formed on the transparent substrate 100 is a case the metal decoration 200 and the finely curved parts 102 are disposed in an overlapped area in planar projection.

The finely curved parts 102 may be formed on one surface or the other surface of the transparent substrate 100 according to requirements and design specifications. As an example, the finely curved parts 102 may be formed on the inner surface (one surface) of the transparent substrate 100, and the metal decoration 200 may be formed on one surface of the transparent substrate 100 to cover the finely curved parts 102.

The finely curved parts 102 may be formed by processing the surface of the transparent substrate 100 by using at least one processing method of sandblasting, etching, plasma-etching, laser processing, and mechanical processing, and the present invention is not limited or restricted by the processing method of the finely curved parts 102. In some cases, without surface processing of the transparent substrate, a polymer resin layer having a curve or a scattering layer including micro beads is formed on the surface of the transparent substrate, and thus the scattering layer may serve as the finely curved parts. The scattering layer may be provided by mixing and then curing the micro beads in a general resin such as an UV curing resin or ink. For reference, the finely curved parts 102 may be formed in a regular or irregular shape and the fine curve of the finely curved part may have a height of approximately 0.1 μm to 50 μm.

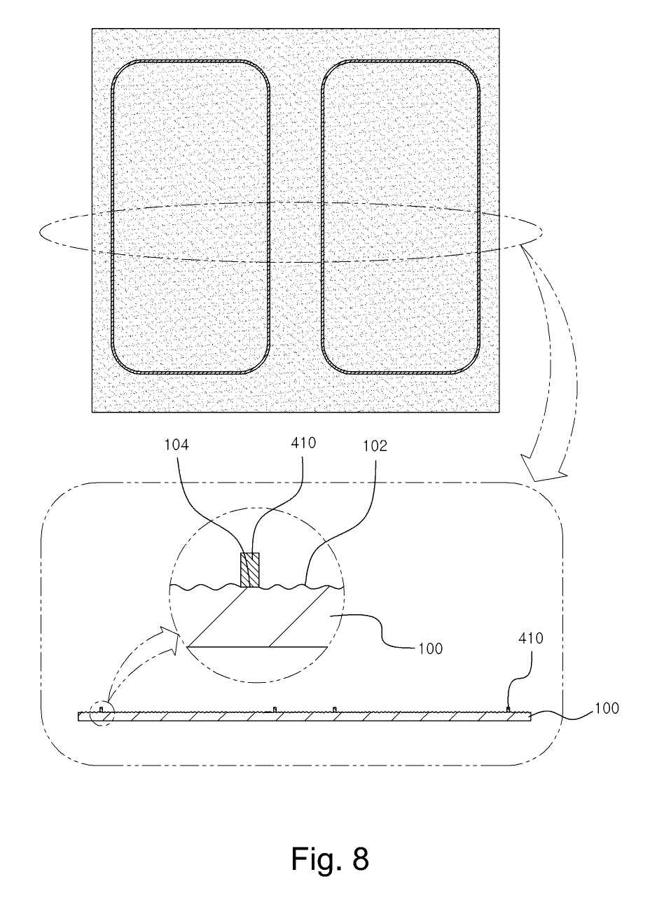

Referring to FIG. 7, first, after a masking pattern 410 is formed on the transparent substrate 100 through a printing or photomasking process, as illustrated in FIG. 8, the finely curved parts 102 having random shapes and sizes of 1 to 10 mm may be formed by sandblasting a part without the masking pattern 410. On the other hand, in the case of forming the finely curved parts 102 by laser processing and the like, the finely curved parts 102 may be formed to have regular distances and sizes.

Furthermore, the part with the finely curved parts 102 may have a hazy effect that looks cloudy in addition to a scattering effect in which the light is scattered.

For reference, the transparent substrate 100 may be provided to correspond to at least one electronic device and cut and provided by forming the finely curved parts 102 and then removing the making pattern 410.

Further, a flat part 104 may be provided between the outermost edge of the transparent substrate 100 and the finely curved parts 102. Herein, it may be understood that the flat part 104 is a flat portion in which the finely curved parts 102 are not formed (not processed or not treated). For example, the flat part 104 may be provided to have a width within approximately 1 mm so as to minimize the reflection of light through the flat part 104.

Meanwhile, in the case where the transparent substrate is provided of a glass or tempered glass material, when the aforementioned finely curved parts 102 are formed up to the outermost edge of the transparent substrate 100, due to the characteristic of the glass, at the outermost edge of the transparent substrate 100, glass is damaged and cracks may occur. Particularly, the tempered glass has high strength, but is easily damaged when the cracks occur at the edge. To this end, in the present invention, the non-processed flat part 104 is provided at the relatively weak edge (the outermost edge) of the transparent substrate 100 to prevent the damage and the cracks of the transparent substrate 100.

The flat part 104 may be provided by forming the masking pattern 410 at the portion corresponding to the flat part 104 and removing the masking pattern 410 after forming the finely curved parts 102, when forming the masking pattern 410 for forming the aforementioned finely curved parts 102.

As such, according to the present invention, the finely curved parts 102 and the flat part 104 are provided on the transparent substrate 100 to prevent the reflection of light caused by the metal decoration 200 made of the metallic material. Simultaneously, the light is reflected at the outermost edge to express a unique design effect.

Referring back to FIG. 6, after the finely curved parts 102 are formed, the metal decoration 200 may be formed to cover the finely curved parts 102 and the flat part 104 at the same time.

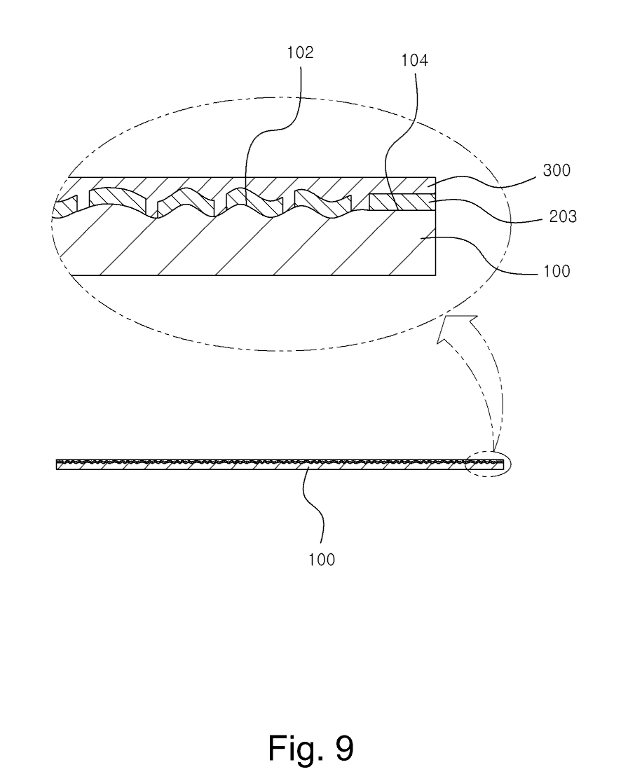

Further, referring to FIG. 9, after the metal decoration 200 is formed to cover the finely curved parts 102 and the flat part 104 of the transparent substrate 100, the printing layer 300 may be formed to cover the metal decoration 200.

Meanwhile, in the exemplary embodiment of the present invention described above, the example in which the finely curved parts and the metal decoration are formed on the same surface (lower surface) of the transparent substrate is described. However, in some cases, the finely curved parts and the metal decoration may be configured to be formed on opposite surfaces of the transparent substrate.

That is, referring to FIG. 10, the metal decoration 200 may be formed on the inner surface of the transparent substrate 100, and finely curved parts 102′ may be formed on the outer surface of the transparent substrate 100 corresponding to the metal decoration 200. Similarly, the printing layer 300 may be formed on the inner surface of the metal decoration 200 to cover the metal decoration 200.

For example, the finely curved parts 102′ may be provided in a hairline structure, a microlens structure, a spin structure, or a random shape, by forming the polymer resin layer or the scattering layer having micro beads on the upper surface of the transparent substrate 100.

In such a structure, light incident to the transparent substrate 100 may be first scattered by passing through the finely curved parts 102′ to minimize the reflection of light caused by the metal decoration 200.

In some cases, the metal decoration and the finely curved parts are formed on the same surface (for example, the outer surface) of the transparent substrate, and after the metal decoration is first formed on the outer surface of the transparent substrate, the finely curved parts may be formed to cover the outer surface of the metal decoration. In this case, the aforementioned scattering layer may be used as the finely curved parts.

Further, in the exemplary embodiment of the present invention described and illustrated above, the example in which the metal decoration 200 is directly formed on the surface of the transparent substrate 100 is described. However, in some cases, after the metal decoration is formed on the rear surface the electronic device, the transparent substrate can be attached to the rear surface the electronic device. Further, unlike this, a coating layer made of a metallic material or other different materials may be formed to cover the metal decoration.

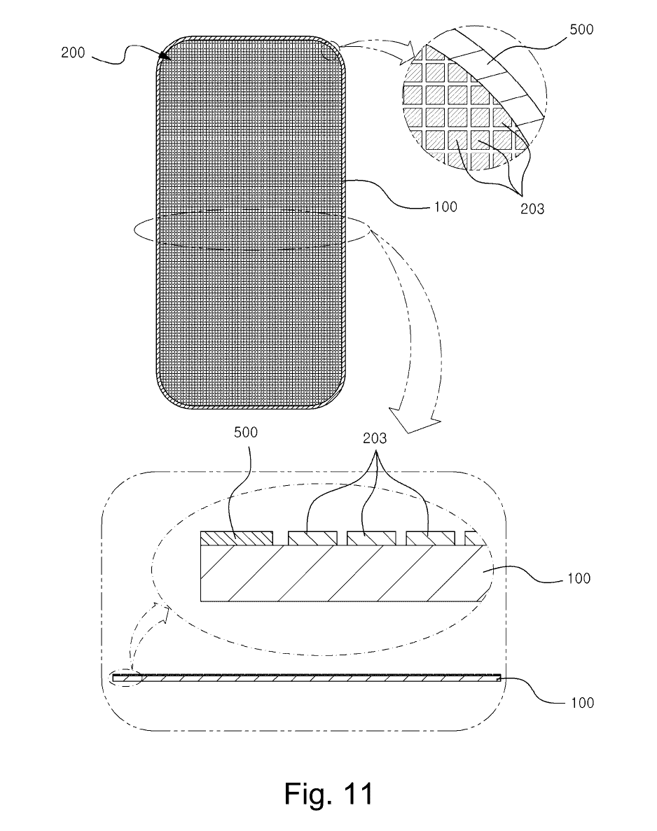

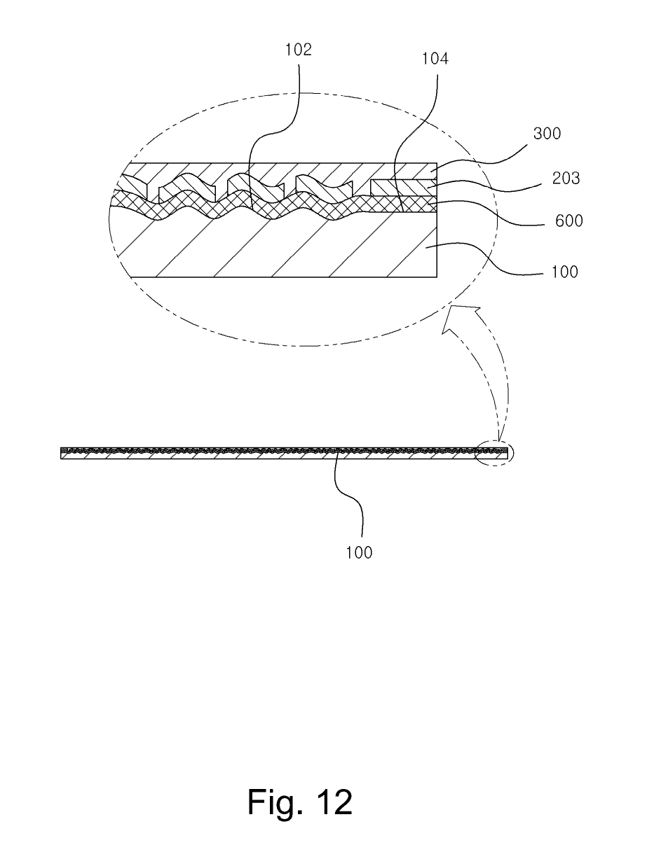

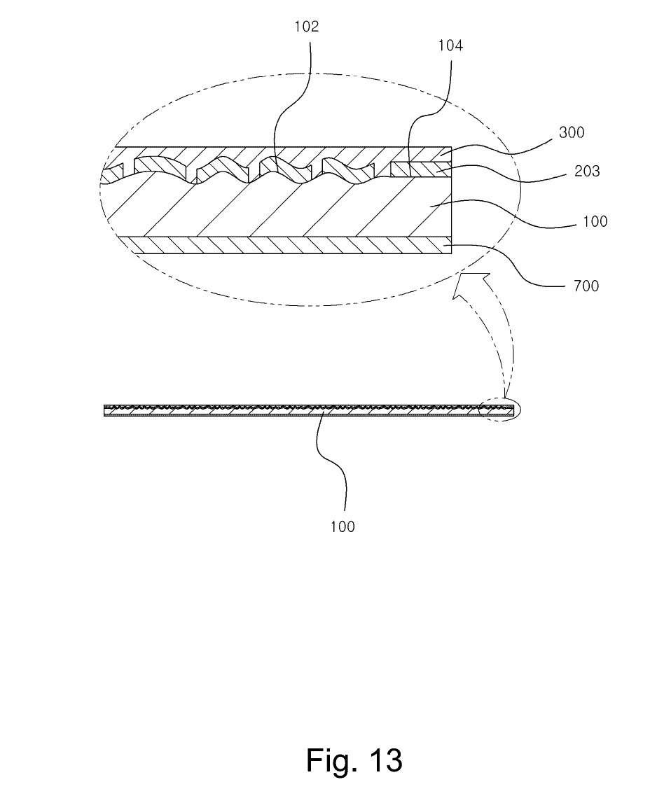

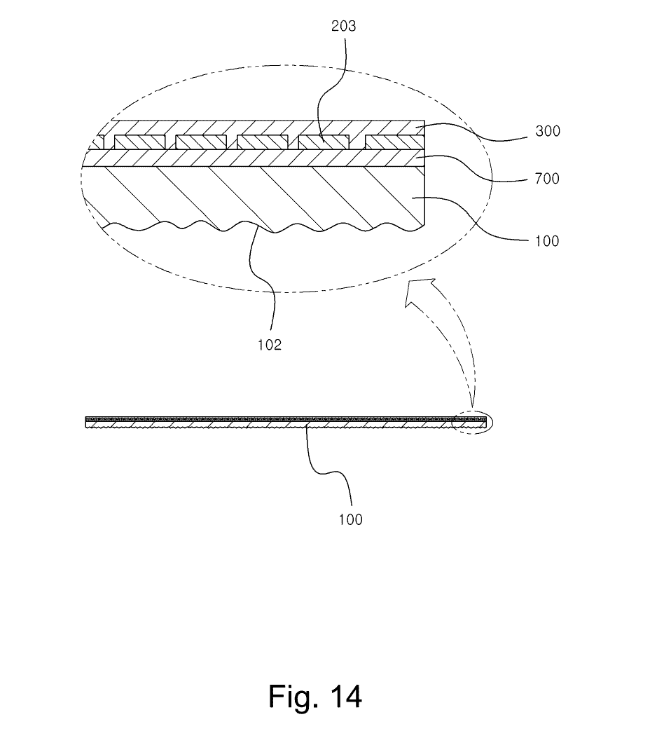

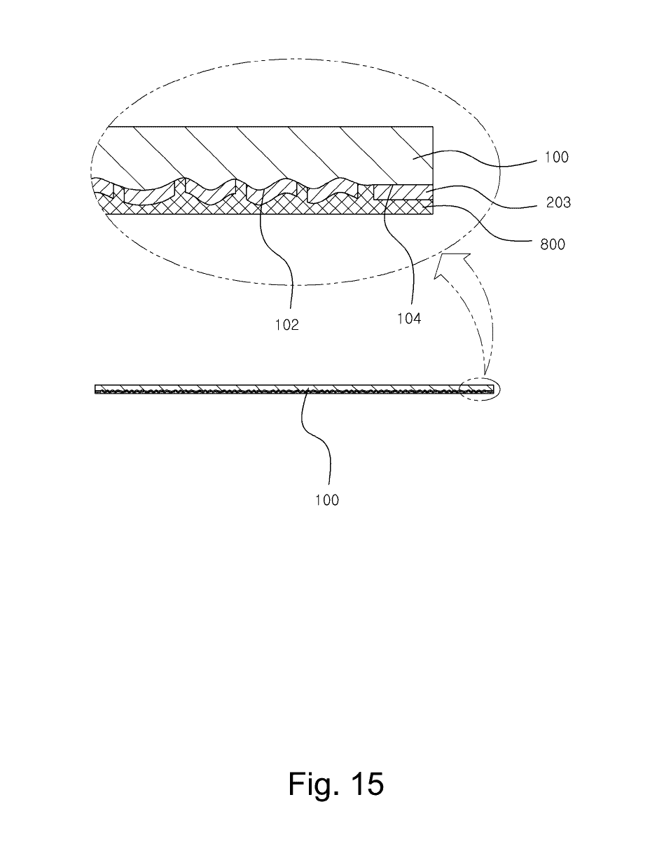

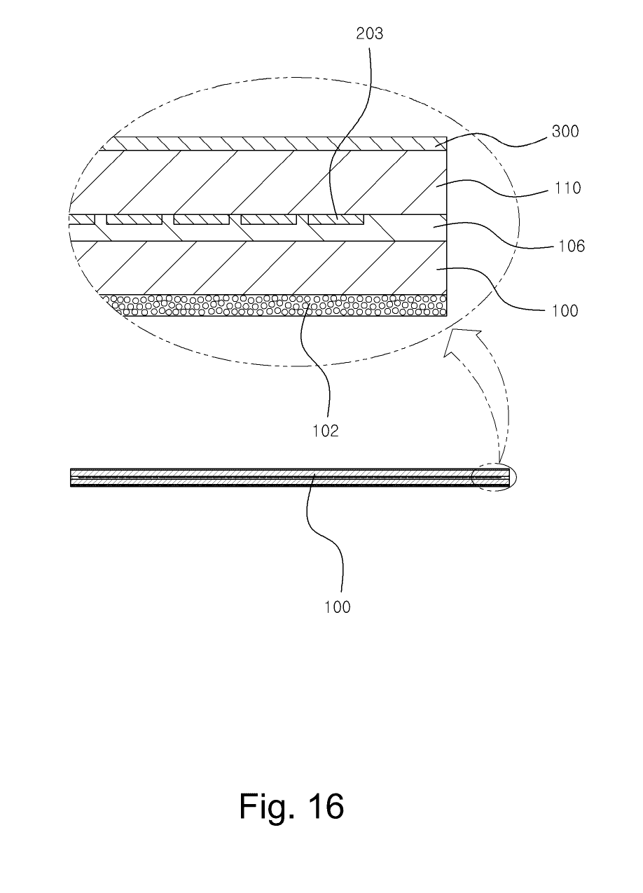

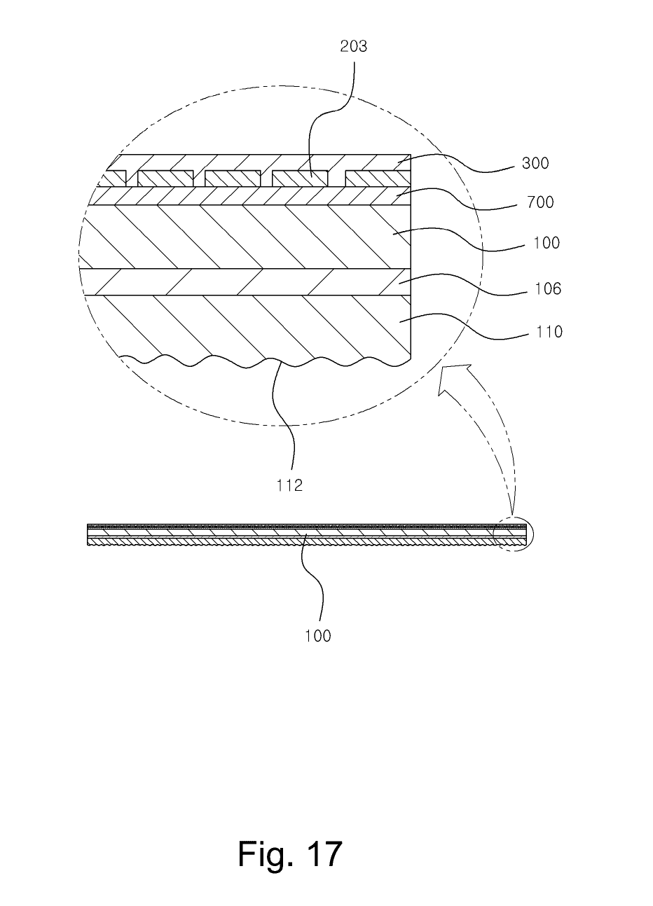

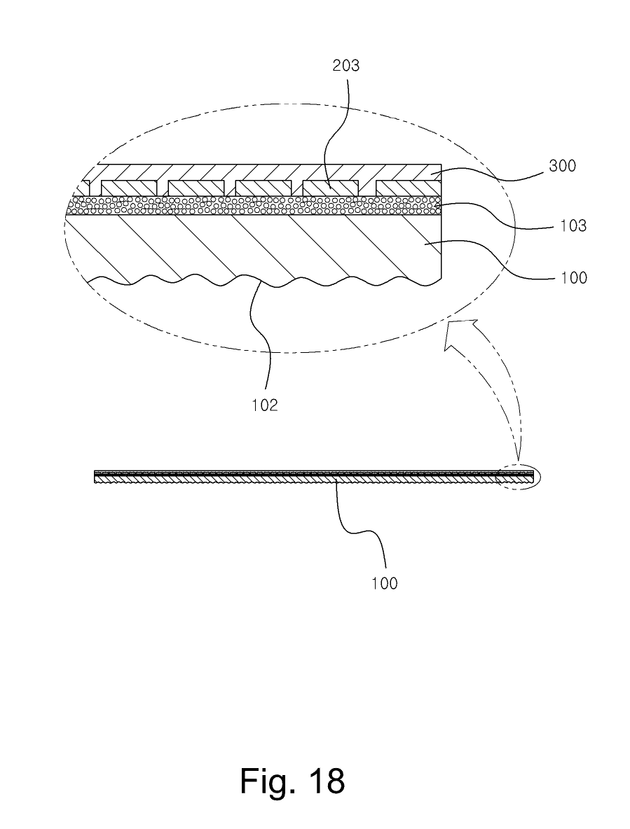

Further, FIG. 11 is a diagram for describing a metal line, as the rear case for the electronic device according to the present invention and FIG. 12 is a diagram for describing an oxide thin-film layer as the rear case for the electronic device according the present invention. In addition, FIGS. 13 and 14 are diagrams for describing an inorganic thin-film layer as the rear case for the electronic device according the present invention and FIG. 15 is a diagram for describing a protective coating layer as the rear case for the electronic device according the present invention. Further, FIGS. 16 and 17 are diagrams for describing a stacked structure with a transparent substrate, as the rear case for the electronic device according the present invention and FIG. 18 is a diagram for describing a modified example of finely curved parts, as the rear case for the electronic device according to the present invention. Furthermore, the same and equivalent parts as the aforementioned configurations designate the same or equivalent reference numerals, and the detailed description thereof will be omitted.

Referring to FIG. 11, the rear case for the electronic device according to the present invention may include a metal line 500 formed along the outermost edge of the transparent substrate 100.

Since the metal line 500 is formed in an area without interfering in the signal lines, the metal line 500 needs not to be provided by the same insulated structure as the metal thin-film FIGS. 203. As an example, the metal line 500 may be formed in an area corresponding to the area with the aforementioned flat part and formed of the same or similar materials as or to the aforementioned metal thin-film figures.

The metal line 500 may reflect metallic light at the outermost edge of the transparent substrate 100 to express more advanced and unique design effects.

Referring to FIG. 12, the rear case for the electronic device according to the present invention may include an oxide thin-film layer 600 formed on the transparent substrate 100, and the metal thin-film FIGS. 203 forming the metal decoration may be formed on the surface of the oxide thin-film layer 600.

The oxide thin-film layer 600 may express much various colors by a refractive effect of light. The oxide thin-film layer 600 may be provided by coating general metal oxide such as TiO₂, SiO₂, and Al₂O₃ in a single-layered or stacked structure, and may be formed by general e-beam evaporation, sputtering, thermal deposition, PECVD, and the like. As an example, the oxide thin-film layer may be generally coated with a thickness of about 10 to 100 nm.

Further, the printing layer 300 (for example, a black, white, or color printing layer) may be formed on the surface of the metal thin-film FIGS. 203. In such a structure, when the thickness of the metal thin-film FIG. 203 is small, the printing color may be transmitted and the transmitted color is mixed with multi-coating colors of the oxide thin-film layer 600 to exhibit a final color, and thus the printing colors may be more variously formed.

Referring to FIG. 13, the rear case for the electronic device according to another exemplary embodiment of the present invention may include an inorganic thin-film layer 700 provided on the transparent substrate 100 to correspond to the finely curved parts 102.

As an example, referring to FIG. 13, the inorganic thin-film layer 700 may be provided to have a different refractive index from the finely curved parts 102 and formed on the outer surface of the transparent substrate 100 to cover the finely curved parts 102. That is, the finely curved parts 102 and the metal thin-film FIGS. 203 may be formed on the inner surface of the transparent substrate 100 and the inorganic thin-film layer 700 may be formed on the transparent substrate 100 to correspond to the metal thin-film FIGS. 203.

As another example, referring to FIG. 14, after the inorganic thin-film layer 700 is first formed on the outer surface of the transparent substrate 100, the metal thin-film FIGS. 203 may be formed on the surface of the inorganic thin-film layer 700 to cover the surface of the inorganic thin-film layer 700.

As the inorganic thin-film layer 700, a transparent thin-film such as a metal oxide film, a metal nitride film, and a metal fluoride film may be used. As an example, the inorganic thin-film layer may be provided by coating various types of thin-films consisting of SiO₂ (1.46), Al₂O₃ (1.7), TiO₂ (2.45), Ta₂O₅ (2.2), ZrO₂ (2.05), HfO₂ (2.0), Nb₂O₅ (2.33), Si₃N₄ (2.02), MgF₂ (1.38), and the like in a single-layered or stacked structure by a method such as sputtering, e-beam evaporation, PECVD, and the like.

The inorganic thin-film layer 700 having a different refractive index from the finely curved parts 102 allows the light incident to the metal thin-film figures to be incident in much various forms to express an advanced design characteristic.

Referring to FIG. 15, the rear case for the electronic device according to the present invention may include a protective coating layer 800 formed on one surface of the transparent substrate 100 to cover the surface of the metal decoration.

As an example, when the protective coating layer 800 is formed in a structure where the metal thin-film FIGS. 203 are exposed to the outside, the protective coating layer 800 may be formed to cover the surface of the metal thin-film figures in order to protect the metal thin-film FIGS. 203. Further, the protective coating layer 800 is formed to cover the surface of the metal thin-film FIGS. 203 to play a role in minimizing the reflection of light of the metal. In some cases, the protective coating layer and the window decoration may be disposed on opposite surfaces of the transparent substrate, respectively. Referring to FIG. 16, the rear case for the electronic device according to the present invention may be provided to be stacked on the rear surface of the electronic device, and the metal thin-film FIGS. 203 forming the metal decoration may be formed on a rear cover 110 of the electronic device to be provided to one surface of the transparent substrate 100.

That is, the metal decoration may be formed on the rear cover 110, and the finely curved parts 102 may be formed on the transparent substrate 100 stacked on the rear cover 110. For reference, in the exemplary embodiment of the present invention, the example in which the finely curved parts are formed on the transparent substrate and the metal decoration is formed on the rear cover is described. However, in the case of the structure where the transparent substrate is stacked on the inner surface of the rear cover, the metal decoration may be formed on the transparent substrate and the finely curved parts may be formed on the rear cover.

The transparent substrate 100 may be attached to the rear cover 110 by using a general adhesive layer 106 or an adhesive film and the printing layer 300 may be formed on the inner surface of the rear cover 110. Unlike this, the metal decoration and the finely curved parts are formed on the transparent substrate and the printing layer may be formed on the rear cover.

Further, referring to FIG. 17, according to another exemplary embodiment of the present invention, the transparent substrate 100 may be provided to be stacked on the inner surface of the rear cover 110 of the electronic device. The finely curved parts 102 may be provided on the outer surface of the rear cover 110, and the inorganic thin-film layer 700, the metal thin-film FIGS. 203, and the printing layer 300 may be sequentially formed on the inner surface of the transparent substrate 100 stacked on the inner surface of the rear cover 110 through the adhesive layer 106.

Referring to FIG. 18, the rear case for the electronic device according to the present invention may be provided by a multilayered structure of finely curved parts 102 and 103. That is, internal finely curved parts 103 may be formed on the inner surface of the transparent substrate 100 and external finely curved parts 103 may be formed on the outer surface of the transparent substrate 100.

The external finely curved parts 102 and the internal finely curved parts 103 may be provided by the same or different shapes. As an example, the external finely curved parts 102 may be provided by processing the outer surface of the transparent substrate 100 and the internal finely curved parts 103 may be provided by forming a polymer resin layer or a scattering layer on the inner surface of the transparent substrate 100. In some case, both the external finely curved parts and the internal finely curved parts may be provided in a form of processing the surface of the transparent substrate or provided in a structure using the polymer resin layer or the scattering layer.

Furthermore, the metal thin-film FIGS. 203 and the printing layer 300 may be sequentially formed on the inner surface of the internal finely curved parts 103. Further, in such a structure, even though the metal thin-film figures are made of a metallic material having relatively low adhesion, the metal thin-film figures are formed on the surface of the internal finely curved parts, thereby more improving the adhesion of the metal thin-film figures.

Although the present invention has been disclosed with reference to the preferred embodiments, those skilled in the art will appreciate that various modifications, additions and substitutions are possible, without departing from the scope and spirit of the invention as disclosed in the accompanying claims.

1] A rear case for an electronic device provided on the rear surface of the electronic device comprising:
a transparent substrate disposed on the rear surface of the electronic device; and
a metal decoration made of a metallic material and provided on one surface of the transparent substrate,
wherein the metal decoration includes a plurality of metal thin-film figures electrically insulated from each other.

2] The rear case for an electronic device of claim 1, wherein finely curved parts corresponding to the metal decoration are formed on the transparent substrate.

3] The rear case for an electronic device of claim 2, wherein the finely curved parts are formed on one surface of the transparent substrate and the metal decoration is provided on one surface of the transparent substrate to cover the finely curved parts.

4] The rear case for an electronic device of claim 2, wherein the finely curved parts are provided on the other surface of the transparent substrate.

5] The rear case for an electronic device of claim 2, wherein the finely curved parts are provided on one surface of the transparent substrate to cover the metal decoration.

6] The rear case for an electronic device of claim 2, wherein a flat part is provided between the outermost edge of the transparent substrate and the finely curved parts.

7] The rear case for an electronic device of claim 2, wherein the finely curved parts are formed by processing the surface of the transparent substrate by using at least one processing method of sandblasting, etching, plasma etching, laser processing, and mechanical processing, or provided by forming a polymer resin layer having a curve or a scattering layer including micro beads on the surface of the transparent substrate.

8] The rear case for an electronic device of claim 1, wherein the plurality of metal thin-film figures is formed in at least one shape of polygons, circles, ovals, and hairlines which are electrically insulated from each other.

9] The rear case for an electronic device of claim 1, wherein the plurality of metal thin-film figures have sizes of 0.1 μm to 0.5 mm and thicknesses of 10 to 500 nm.

10] The rear case for an electronic device of claim 1, wherein the plurality of metal thin-film figures is provided in a single-layered or multilayered structure by using at least one of chromium, aluminum, tin, palladium, molybdenum, copper, gold, titanium, and indium.

11] The rear case for an electronic device of claim 1, further comprising:
a printing layer formed on the lower surface of the metal decoration.

12] The rear case for an electronic device of claim 1, further comprising:
a metal line formed along the outermost edge of the transparent substrate.

13] The rear case for an electronic device of claim 1, further comprising:
an oxide thin-film layer formed on the transparent substrate,
wherein the metal decoration is formed on the surface of the oxide thin-film layer.

14] The rear case for an electronic device of claim 2, wherein an inorganic thin-film layer corresponding to the finely curved parts is formed on the transparent substrate.

15] The rear case for an electronic device of claim 1, further comprising:
a protective coating layer formed on one surface of the transparent substrate to cover the metal decoration.

16] The rear case for an electronic device of claim 1, wherein the transparent substrate is provided to be stacked on the rear surface of the electronic device, and the metal decoration is formed on the rear surface of the electronic device to be provided on one surface of the transparent substrate.
